(19) United States
(12) Patent Application Publication
(10) Pub. No.: US 2012/0292556 A1
(43) Pub. Date: Nov. 22, 2012

(54) HEAT TRANSFER COMPOSITION OF OXYGENATED LUBRICANT WITH HYDROFLUOROOLEFIN AND HYDROCHLOROFLUOROOLEFIN REFRIGERANTS

(75) Inventor: Brett L. Van Horn, King of Prussia, PA (US)

(73) Assignee: Arkema Inc., King of Prussia, PA (US)

(21) Appl. No.: 13/574,058

(22) PCT Filed: Jan. 25, 2011
(86) PCT No.: PCT/US11/22364

§ 371 Date: Jul. 19, 2012

Related U.S. Application Data
(60) Provisional application No. 61/297,882, filed on Jan. 25, 2010.

(51) Int. Cl. C09K 5/00

(52) U.S. Cl. 252/68

(57) ABSTRACT

The present invention relates to heat transfer compositions comprising an oxygenaged lubricant comprising polyvinyl ether oil and a refrigerant comprising hydrofluoroolefins and/or hydrochlorofluoroolefins. The heat transfer compositions of the present invention have the benefit of exhibiting superior thermal stability and are useful in such applications as refrigeration, air conditioning, and heat transfer systems.

### FIELD OF THE INVENTION

The present invention relates to heat transfer compositions comprising an oxygenaged lubricant comprising polyvinyl ether oil and a refrigerant comprising hydrofluoroolefins and/or hydrochlorofluoroolefins. The heat transfer compositions of the present invention have the benefit of exhibiting superior thermal stability and are useful in such applications as refrigeration, air conditioning, and heat transfer systems.

### BACKGROUND OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications. Though they are deemed “friendly” to the ozone layer they still generally possess high global warming potentials. One new class of compounds that has been identified to replace ozone depleting or high global warming substances are halogenated olefins, such as hydrofluoroolefins (HFO) and hydrochlorofluoroolefins (HCFO). Because of the presence of alkene linkage it is expected that the HFOs and HCFOs will be chemically unstable, relative to HCFCs or CFCs. The inherent chemical instability of these materials in the lower atmosphere results in short atmospheric lifetimes, which provide the low global warming potential and zero or near-zero ozone depletion properties desired. However, such inherent instability is believed to also impact the commercial application of such materials.

Degradation of HFOs or HCFOs used in refrigeration, air conditioning, or heat transfer systems can degrade system performance, produce toxic or corrosive by-products, result in premature failure of the equipment, or other problems. Identifying combinations of HFO and/or HCFO refrigerants with lubricating oils that are thermally and chemically stable enough to be used in refrigeration, air conditioning, or heat transfer equipment is therefore very important.

It is known that different combinations of refrigerant and lubricant will have varying degrees of thermal/chemical stability. So though a particular combination of HFO or HCFO with a lubricant may be found that displays acceptable thermal/chemical stability to be used in a refrigeration, air conditioning, or heat transfer system, it is greatly preferred to have a lubricant that provides superior stability over a broad range of HFO and HCFO refrigerants to limit the risk that an incompatible combination is used or to limit the degree of degradation of the refrigerant and/or lubricant during use.

### DETAILED DESCRIPTION OF INVENTION

With continued regulatory pressure there is a growing need to identify more environmentally sustainable replacements for refrigerants, heat transfer fluids, foam blowing agents, solvents, and aerosols with lower ozone depleting and global warming potentials. Chlorofluorocarbon (CFC) and hydrochlorofluorocarbons (HCFC), widely used for these applications, are ozone depleting substances and are being phased out in accordance with guidelines of the Montreal Protocol. Hydrofluorocarbons (HFC) are a leading replacement for CFCs and HCFCs in many applications; though they are deemed “friendly” to the ozone layer they still generally possess high global warming potentials. One new class of compounds that has been identified to replace ozone depleting or high global warming substances are halogenated olefins, such as hydrofluoroolefins (HFO) and hydrochlorofluoroolefins (HCFO). Because of the presence of alkene linkage it is expected that the HFOs and HCFOs will be chemically unstable, relative to preceding HCFC, CFC, or RFC. The inherent chemical instability of these materials in the lower atmosphere results in short atmospheric lifetimes, which provide the low global warming potential and zero or near-zero ozone depletion properties desired. However, such inherent instability is believed to also impact the commercial application of such materials, which may degrade during storage, handling and use, such as when exposed to high temperatures or when contacted with other compounds e.g., moisture, oxygen, or other compounds with which they may undergo condensation reactions. This degradation may occur when halo-olefins are used as working fluids in heat transfer equipment (refrigeration or air-conditioning equipment, for instance) or when used in some other application. This degradation may occur by any number of different mechanisms. In one instance, the degradation may be caused by instability of the compounds at extreme temperatures. In other instances, the degradation may be caused by oxidation in the presence of air that has inadvertently leaked into the system. Whatever the cause of such degradation, because of the instability of the halo-olefins, it may not be practical to incorporate these halo-olefins into refrigeration or air-conditioning systems.

Good understanding of the chemical interactions of the refrigerant, lubricant, and metals in a refrigeration system is necessary for designing systems that are reliable and have a long service life. Incompatibility between the refrigerant and other components of or within a refrigeration or heat transfer system can lead to decomposition of the refrigerant, lubricant, and/or other components, the formation of undesirable byproducts, corrosion or degradation of mechanical parts, loss of efficiency, or a general shortening of the service life of the equipment, refrigerant and/or lubricant.

In a refrigeration, air conditioning, or heat transfer system, lubricating oil and refrigerant are expected to be in contact with each other in at least some parts of the system, if not most of the system, as explained in the ASHRAE Handbook: HVAC Systems and Equipment. Therefore, whether the lubricant and refrigerant are added separately or as part of a pre-mixed package to a refrigeration, air conditioning, or heat transfer system, they are still expected to be in contact within the system and must therefore be compatible.

The general poor miscibility of HFC refrigerants with tranditional mineral oil lubricants resulted in the development and use of several oxygenated lubricants, including mainly polyalkylene glycol (FAG) oils and polyol ester (POE) oils. With the development of HFO-1234yf (2,3,3,3-tetrafluoropropene) for use in mobile air conditioning, it has been proposed that PAG and POE can be used with HFO-1234yf. However, available data such as presented by C. Puhl (VDA Winter Meeting, Saalfeldon 2009. “Refrigeration Oils for Future Mobile A/C Systems”) suggest that combinations of HFO-1234yf with PAG or POE may not possess the same level of thermal/chemical stability of HFC-134a with PAG or POE. It has also been shown that other HFOs, such as HFO-1234ze (1,3,3,3-tetrafluoropropene), may have lower stability in PAG oil than HFO-1234yf. The lower thermal stability may preclude HFO-1234ze from being used in some applications. PAG oils have been found to generally not

Polyvinyl ether (PVE) oils are another type of oxygenated refrigeration oil that has been developed for use with HFC refrigerants. Commercial examples of PVE refrigeration oil include FVC32D and FVC68D produced by Idemitsu. In the present invention, heat transfer combinations comprising PVE oil with HFO and/or HCFO containing refrigerants are shown to possess superior thermal/chemical stability than such combinations with PAG or POE oils in the absence of PVE oil. The present invention is useful in providing additional refrigerant/lubricant combinations with acceptable stability for use in standard equipment.

Though not meant to limit the scope of the present invention in any way, in an embodiment of the present invention, the polyvinyl ether oil includes those taught in the literature such as described in U.S. Pat. Nos. 5,399,631 and 6,454,960. In another embodiment of the present invention, the polyvinyl ether oil is composed of structural units of the type shown by Formula 1:

—[C(R₁,R₂)—C(R₃,—O—R₄)]— Formula 1

Where R₁, R₂, R₃, and R₄ are independently selected from hydrogen and hydrocarbons, where the hydrocarbons may optionally contain one or more ether groups. In a preferred embodiment of the present invention, R₁, R₂ and R₃ are each hydrogen, as shown in Formula 2:

—[CH₂—CH(—O—R₄)]— Formula 2

In another embodiment of the present invention, the polyvinyl ether oil is composed of structural units of the type shown by Formula 3:

—[CH₂—CH(—O—R₅)]ₘ—[CH₂—CH(—O—R₆)]ₙ— Formula 3

Where R₅ and R₆ are independently selected from hydrogen and hydrocarbons and where m and n are integers.

Though not meant to limit the scope of the present invention in any way, the refrigerants of the present invention comprise at least one HFO or HCFO, such as, but not limited to a C3 through C6 alkene containing at least one fluorine and optionally containing at least one chlorine. In a preferred embodiment of the present invention, the HFO or HCFO contains a CF3-terminal group. In another preferred embodiment of the present invention the HFO is selected from the group consisting of 3,3,3-trifluorpropene (HFO-1234zf), 1,3,3,3-tetrafluoropropene (HFO-1234ze), particularly the trans-isomer, 2,3,3,3-tetrafluoropropene (HFO-1234yf), 1,2,3,3,3-pentafluoropropene (HFO-1255ye), particularly the Z-isomer, E-1,1,1,3,3,3-hexafluorobut-2-ene (E-HFO-1336mzz), Z-1,1,1,3,3,3-hexafluorobut-2-ene (Z-HFO-1336mzz), 1,1,1,4,4,5,5,5-octafluoropent-2-ene (HFO-1438mzz), and mixtures thereof. Preferably the HFO is selected from the group consisting of HFO-1243zf, trans-HFO-1234ze, HFO-1234yf, and mixtures thereof. In another embodiment of the present invention, the HCFO is selected from the group consisting of a mono-chlorofluoropropene, a di-chlorofluoropropene, and mixtures thereof. In another embodiment of the present invention, the HCFO is selected from 1-chloro-3,3,3-trifluoropropene (HCFO-1233zd), particularly the trans-isomer, 2-chloro-3,3,3-trifluoropropene (HCFO-1233xf), and mixtures thereof.

The HFO and/or HCFO refrigerants of the present invention may be used in combination with other refrigerants such as hydro fluorocarbons, hydrochlorofluorocarbons, hydrofluoroolefins, hydrofluorochlorocarbons, hydrocarbons, hydrofluoroethers, fluoroketones, chlorofluorocarbons, trans-1,2-dichloroethylene, carbon dioxide, ammonia, dimethyl ether, and mixtures thereof. Exemplary hydrofluorocarbons include difluoromethane (HFC-32); 1-fluoroethane (HFC-161); 1,1-difluoroethane (HFC-152a); 1,2-difluoroethane (HFC-152); 1,1,1-trifluoroethane (HFC-143a); 1,1,2-trifluoroethane (HFC-143); 1,1,1,2-tetrafluoroethane (HFC-134a); 1,1,2,2-tetrafluoroethane (HFC-134); 1,1,1,2,2-pentafluoroethane (HFC-125); 1,1,1,3,3-pentafluoropropane (HFC-245fa); 1,1,2,2,3-pentafluoropropane (HFC-245ca); 1,1,1,2,3-pentafluoropropane (HFC-245eb); 1,1,1,3,3,3-hexafluoropropane (HFC-236fa); 1,1,1,2,3,3,3-heptafluoropropane (HFC-227ea); 1,1,1,3,3-pentafluorobutane (HFC-365mfc), 1,1,1,2,3,4,4,5,5,5-decafluoropropane (HFC-4310), and mixtures thereof. Exemplary chlorofluorocarbons include trichlorofluoromethane (R-11), dichlorodifluoromethane (R-12), 1,1,2-trifluoro-1,2,2-trifluoroethane (R-113), 1,2-dichloro-1,1,2,2-tetrafluoroethane (R-114), chloro-pentafluoroethane (R-115) and mixtures thereof. Exemplary hydrocarbons include propane, butane, isobutane, n-pentane, iso-pentane, neo-pentane, cyclopentane, and mixtures thereof. Exemplary hydrofluoroolefins include 3,3,3-trifluorpropene (HFO-1234zf, E-1,3,3,3-tetrafluoropropene (E-HFO-1234ze), Z-1,3,3,3-tetrafluoropropene (Z-HFO-1234ze), 2,3,3,3-tetrafluoropropene (HFO-1234yf), E-1,2,3,3,3-pentafluoropropene (E-HFO-1255ye), Z-1,2,3,3,3-pentafluoropropene (Z-HFO-1225ye), E-1,1,1,3,3,3-hexafluorobut-2-ene (E-HFO-1336mzz), Z-1,1,1,3,3,3-hexafluorobut-2-ene (Z-HFO-1336mzz), 1,1,1,4,4,5,5,5-octafluoropent-2-ene (HFO-1438mzz) and mixtures thereof. Exemplary hydrofluoroethers include 1,1,1,2,2,3,3-heptafluoro-3-methoxy-propane, 1,1,1,2,2,3,3,4,4-nonafluoro-4-methoxy-butane and mixtures thereof. An exemplary fluoroketone is 1,1,1,2,2,4,5,5,5-nonafluoro-4(trifluoromethyl)-3-3pentanone. Exemplary hydrochlorofluorocarbons include chloro-difluoromethane (HCFC-22), 1-chloro-1,1-difluoroethane (HCFC-142b), 1,1-dichloro-1-fluoroethane (HCFC-141b), 1,1-dichloro-2,2,2-trifluoroethane (HCFC-123), and 1-chloro-1,2,2,2-tetrafluoroethane (HCFC-124). Exemplary hydrochlorofluoroolefins include 1-chloro-3,3,3-trifluoropropene (HCFO-1233zd), particularly the trans-isomer, 2-chloro-3,3,3-trifluoropropene (HCFO-1233xf), and dichloro-tetrafluoropropenes, such as isomers of HCFO-1214.

In embodiment of the present invention, the refrigerant composition comprises from about 1 to 100 wt % HFO and/or HCFO. In another embodiment of the present invention, the refrigerant composition comprises from about 50 to 100 wt % HFO and/or HCFO.

In an embodiment of the present invention, the lubricating oil comprises polyvinyl ether lubricating oil. In another embodiment of the present invention, the lubricating oil comprises about 50 to 100% polyvinyl ether lubricating oil. The PVE lubricating oil may optionally contain other lubricants, preferably oxygenated lubricants, including, but not limited to polyalkylene glycol oil, polyol ester oil, polyglycol oil, and mixtures thereof.

The thermal/chemical stability of refrigerant/lubricant mixtures can be evaluated using various tests known to those of skill the art, such as ANSI/ASHRAE Standard 97-2007 (ASHRAE 97). In such a test, mixtures of refrigerant and lubricant, optionally in the presence of catalyst or other materials including water, air, metals, metal oxides, ceramics, etc, are typically aged at elevated temperature for a predetermined aging period. After aging the mixture is analyzed to evaluate any decomposition or degradation of the mixture. A typical composition for testing is a 50/50 wt/wt mixture of refrigerant/lubricant, though other compositions can be used. Typically, the aging conditions are at from about 140° C. to 200° C. for from 1 to 30 days; aging at 175° C. for 14 days is very typical.

Multiple techniques are typically used to analysis the mixtures following agent. A visual inspection of the liquid fraction of the mixture for any signs of color change, precipitation, or heavies, is used to check for gross decomposition of either the refrigerant or lubricant. Visual inspection of any metal test pieces used during testing is also done to check for signs of corrosion, deposits, etc. Halide analysis is typically performed on the liquid fraction to quantify the concentration of halide ions (eg. fluoride) present. An increase in the halide concentration indicates a greater fraction of the halogenated refrigerant has degraded during aging and is a sign of decreased stability. The Total Acid Number (TAN) for the liquid fraction is typically measured to determine the acidity of the recovered liquid fraction, where an increase in acidity is a sign of decomposition of the refrigerant, lubricant, or both. GC-MS is typically performed on the vapor fraction of the sample to identify and quantify decomposition products.

The effect of water on the stability of the refrigerant/lubricant combination can be evaluated by performing the aging tests at various levels of moisture ranging from very dry (<10 ppm water) to very wet (>10000 ppm water). Oxidative stability can be evaluated by performing the aging test either in the presence or absence of air.

To evaluate the relative stability of HFO refrigerants in oxygenated lubricants, a series of aging tests, such as those described above, would be performed on a set of refrigerant/lubricant combinations, optionally containing catalysts or other materials as described above. The lubricants to be tested would at least include a commercial PVE oil, a commercial POE oil, and a commercial PAG oil. Exemplary HFOs to test in combination with the oxygenated lubricants include HFO-1234yf (2,3,3,3-tetrafluoropropene), trans-HFO-1234ze (trans-1,3,3,3-tetrafluoropropene), HFO-1243zf (3,3,3-trifluoropropene). Exemplary HCFOs to test in combination with the oxygenated lubricants include trans-HCFO-1233zd (trans-1-chloro-3,3,3-trifluoropropene) and HCFO-1233xf (2-chloro-3,3,3-trifluoropropene).

1. A heat transfer composition comprising a polyvinyl ether oil and a refrigerant selected from the group consisting of hydrofluoroolefins, hydrochlorofluoroolefins, and mixtures thereof.

2. The heat transfer composition of claim 1 wherein said polyvinyl ether oil comprises structural units of the formula —[C(R₁,R₂)—C(R₃,—O—R₄)]—, wherein R₁, R₂, R₃, and R₄ are selected from the group consisting of hydrogen and hydrocarbons, and wherein the hydrocarbons optionally contain one or more ether groups.

3. The heat transfer composition of claim 1 wherein s R₁, R₂ and R₃ are each hydrogen.

4. The heat transfer composition of claim 1 formula —[CH₂—CH(—O—R₅)]ₘ[CH₂—CH(—O—R_{y})]ₙ—, wherein R₅ and R₆ are independently selected from hydrogen and hydrocarbons and where m and n are integers.

5. The heat transfer composition of claim 1 wherein said at least one HFO comprises a C3 through C6 alkene containing at least one fluorine.

6. The heat transfer composition of claim 5 wherein said a C3 through C6 alkene contains a CF3- terminal group.

7. The heat transfer composition of claim 1 wherein said HFO is selected from the group consisting of 3,3,3-trifluorpropene (HFO-1234zf), 1,3,3,3-tetrafluoropropene (HFO-1234ze), particularly the trans-isomer, 2,3,3,3-tetrafluoropropene (HFO-1234yf), 1,2,3,3,3-pentafluoropropene (HFO-1255ye), particularly the Z-isomer, E-1,1,1,3,3,3-hexafluorobut-2-ene (E-HFO-1336mzz), Z-1,1,1,3,3,3-hexafluorobut-2-ene (Z-HFO-1336mzz), 1,1,1,4,4,5,5,5-octafluoropent-2-ene (HFO-1438mzz), and mixtures thereof Preferably the HFO is selected from the group consisting of HFO-1243zf, trans-HFO-1234ze, HFO-1234yf, and mixtures thereof.

8. The heat transfer composition of claim I wherein said at least one HCFO comprises a C3 through C6 alkene containing at least one fluorine and at least one chlorine.

9. The heat transfer composition of claim 8 wherein said HCFO contains a CF3-terminal group.

10. The heat transfer composition of claim 1 wherein said at least one HCFO is selected from the group consisting of 1-chloro-3,3,3-trifluoropropene (HCFO-1233zd), 2-chloro-3,3,3-trifluoropropene (HCFO-1233xf), and dichloro-tetrafluoropropenes.

11. The heat transfer composition of claim 1 further comprising a refrigerant selected from the group consisting of hydrofluorocarbons, hydrochlorofluorocarbons, hydrofluoroolefins, hydrofluorochlorocarbons, hydrocarbons, hydrofluoroethesr, fluoroketones, chlorofluorocarbons, trans-1,2-dichloroethylene, carbon dioxide, ammonia, dimethyl ether, and mixtures thereof.
